(19) United States
(12) Patent Application Publication
(10) Pub. No.: US 2021/0336566 A1
(43) Pub. Date: Oct. 28, 2021

(54) RANGING APPARATUS AND SCAN MECHANISM THEREOF, CONTROL METHOD, AND MOBILE PLATFORM

(71) Applicant: SZ DJI TECHNOLOGY CO., LTD., Shenzhen (CN)

(72) Inventors: Chenghui LONG, Shenzhen (CN); Wanqi LIU, Shenzhen (CN); Jin ZHAO, Shenzhen (CN); Huan HE, Shenzhen (CN)

(21) Appl. No.: 17/370,458

(22) Filed: Jul. 8, 2021

Related U.S. Application Data
(63) Continuation of application No. PCT/CN2019/071011, filed on Jan. 9, 2019.

(51) Int. Cl. H02P 6/04; G01S 7/481

(52) U.S. Cl. CPC H02P 6/04; G01S 7/4817

(57) ABSTRACT

A scan mechanism of a ranging apparatus includes a plurality of optical elements, a plurality of motors, and a controller or a plurality of controllers. The plurality of motors correspond to the plurality of optical elements. A motor includes a hollow rotor. An optical element is arranged at the rotor of a corresponding motor. The controller controls the plurality of motors. At least one of the plurality of controllers controls at least two of the plurality of motors. When one controller controls at least two motors, the controller controls the at least two motors to rotate at a predetermined angle difference based on a first synchronization strategy. When one controller controls one motor, the controller controls the motor and another at least one motor to rotate at the predetermined angle difference based on a second synchronization strategy.

### CROSS-REFERENCE TO RELATED APPLICATION

This application is a continuation of International Application No. PCT/CN2019/071011, filed Jan. 9, 2019, the entire content of which is incorporated herein by reference.

### TECHNICAL FIELD

The present disclosure generally relates to the ranging field and, more particularly, to a ranging apparatus and a scan mechanism thereof, a control method, and a mobile platform.

### BACKGROUND

A ranging apparatus, such as a LIDAR, calculates a distance to a to-be-measured object according to flight time of a measurement laser in the air. The LIDAR, which is configured to detect in a large angle range of 360°, uses an optical element such as a prism to cause a laser emission direction to deflect. To cause the laser to have different deflection directions at different moments, the prism needs to be rotated. A motor is combined with the prism and drives the prism to rotate to cause a laser beam to deflect at different angles to form a scan trajectory.

In the ranging apparatus, two or more prisms need to be rotated. Thus, a plurality of motors form a motor module to drive a set of prisms to rotate. When the plurality of motors rotate at a constant speed of a determined target speed, a scan trajectory of firmware is formed. However, in an application, since the rotation speed of the motor fluctuates, the motor cannot operate at an absolutely constant speed. Therefore, when the plurality of motors operate separately, since speed fluctuation causes an angle phase difference to fluctuate, the scan trajectory is caused to flicker, which impacts a final detection effect.

### SUMMARY

Embodiments of the present disclosure provide a scan mechanism of a ranging apparatus including a plurality of optical elements, a plurality of motors, and a controller or a plurality of controllers. The plurality of motors correspond to the plurality of optical elements. A motor includes a hollow rotor. An optical element is arranged at the rotor of a corresponding motor. The controller controls the plurality of motors. At least one of the plurality of controllers controls at least two of the plurality of motors. When one controller controls at least two motors, the controller controls the at least two motors to rotate at a predetermined angle difference based on a first synchronization strategy. When one controller controls one motor, the controller controls the motor and another at least one motor to rotate at the predetermined angle difference based on a second synchronization strategy.

Embodiments of the present disclosure provide a ranging apparatus including a housing, a ranging device, a scan mechanism, and a main control circuit. The ranging device is configured to emit a light pulse sequence and receive a light pulse sequence reflected by a detected object. The scan mechanism is configured to change a transmission direction of at least a light pulse sequence emitted by an emission device and then emit the light pulse sequence. The scan mechanism includes a plurality of optical elements, a plurality of motors, and a controller or a plurality of controllers. The plurality of motors correspond to the plurality of optical elements. A motor includes a hollow rotor. An optical element is arranged at the rotor of a corresponding motor. The controller controls the plurality of motors. At least one of the plurality of controllers controls at least two of the plurality of motors. When one controller controls at least two motors, the controller controls the at least two motors to rotate at a predetermined angle difference based on a first synchronization strategy. When one controller controls one motor, the controller controls the motor and another at least one motor to rotate at the predetermined angle difference based on a second synchronization strategy. The main control circuit is fixed at the housing and configured to control the controller to operate.

Embodiments of the present disclosure provide a mobile platform including a platform body and a ranging apparatus. The ranging apparatus is arranged at the platform body and includes a housing, a ranging device, a scan mechanism, and a main control circuit. The ranging device is configured to emit a light pulse sequence and receive a light pulse sequence reflected by a detected object. The scan mechanism is configured to change a transmission direction of at least a light pulse sequence emitted by an emission device and then emit the light pulse sequence. The scan mechanism includes a plurality of optical elements, a plurality of motors, and a controller or a plurality of controllers. The plurality of motors correspond to the plurality of optical elements. A motor includes a hollow rotor. An optical element is arranged at the rotor of a corresponding motor. The controller controls the plurality of motors. At least one of the plurality of controllers controls at least two of the plurality of motors. When one controller controls at least two motors, the controller controls the at least two motors to rotate at a predetermined angle difference based on a first synchronization strategy. When one controller controls one motor, the controller controls the motor and another at least one motor to rotate at the predetermined angle difference based on a second synchronization strategy. The main control circuit is fixed at the housing and configured to control the controller to operate.

### BRIEF DESCRIPTION OF THE DRAWINGS

FIG. 1 is a schematic structural diagram of a ranging apparatus according to some embodiments of the present disclosure.

FIG. 2 is a schematic structural block diagram of the ranging apparatus according to some embodiments of the present disclosure.

FIG. 3 is a schematic diagram showing an optical path of the ranging apparatus according to some embodiments of the present disclosure.

FIG. 4A is a schematic structural diagram of a scan mechanism according to some embodiments of the present disclosure.

FIG. 4B is a schematic structural diagram of a scan mechanism according to some other embodiments of the present disclosure.

FIG. 4C is a schematic structural diagram of a scan mechanism according to some other embodiments of the present disclosure.

FIG. 5 is a schematic structural diagram of a scan mechanism according to some other embodiments of the present disclosure.

FIG. 6A is a schematic diagram showing a relationship between two motors according to some embodiments of the present disclosure.

FIG. 6B is a schematic diagram showing a relationship between two motors according to some other embodiments of the present disclosure.

FIG. 7 is a schematic structural diagram of a position detection device according to some embodiments of the present disclosure.

FIG. 8A is a schematic diagram showing a pulse sequence output by the position detection device in FIG. 7.

FIG. 8B is a schematic diagram showing processing of a main control circuit according to some embodiments of the present disclosure for the pulse sequence of the position detection device in FIG. 7.

FIG. 9 is a schematic structural block diagram of a mobile platform according to some embodiments of the present disclosure.

FIG. 10 is a schematic flowchart of a control method of the ranging apparatus on the main controller side according to some embodiments of the present disclosure.

FIG. 11 is a schematic flowchart of a control method of the ranging apparatus on a secondary controller side according to some embodiments of the present disclosure.

Reterence numerals:

| | |
|---|---|
| 10 | Platform body; |
| 20 | Ranging apparatus; |
| 1 | Housing; |
| 2 | Ranging module; |
| 101 | Detected object; |
| 103 | Emitter; |
| 104 | Collimation element; |
| 105 | Detector; |
| 106 | Optical path change element; |
| 109 | Rotation axis; |
| 110 | Emission device; |
| 111, 112, 113 | Light; |
| 114 | First optical element; |
| 115 | Second optical element; |
| 116, 117 | Driver; |
| 118 | Controller; |
| 119 | Collimated beam; |
| 120 | Reception device; |
| 130 | Sampling device; |
| 140 | Computation device; |
| 150 | Control circuit; |
| 3 | Scan mechanism; |
| 31 | Motor; |
| 32 | Optical element; |
| 33 | Electronic speed controller (ESC); |
| 331 | Controller; |
| 4 | Main control circuit; |
| 5 | Crystal oscillator; |
| 6 | Position detection device; |
| 60 | Opening; |
| 61 | Encoder disc; |
| 611 | First detection group; |
| 611a | First light transmission region; |
| 611b | First non-light transmission region; |
| 612 | Second detection group; |
| 612a | Second light transmission region; |
| 612b | Second non-light transmission region; |
| 62 | Light switch |

### DETAILED DESCRIPTION OF THE EMBODIMENTS

The technical solution of the present disclosure is described in detail in connection with the accompanying drawings of embodiments of the present disclosure. Described embodiments are merely some embodiments of the present disclosure, not all embodiments. Based on embodiments of the present disclosure, all other embodiments obtained by those of ordinary skill in the art without creative efforts are within the scope of the present disclosure.

A ranging apparatus and a scan mechanism thereof, a control method, and a mobile platform are described in detail in connection with the accompanying drawings below. When there is no conflict, embodiments and features of embodiments can be combined with each other.

With reference to FIG. 1, embodiments of the present disclosure provide a ranging apparatus 20. The ranging apparatus 20 includes a housing 1, a ranging module 2, a scan mechanism 3, and a main control circuit 4. The ranging module 2 may be configured to emit a light pulse sequence and receive a light pulse sequence reflected by a detected object. The scan mechanism 3 may be configured to change a propagation direction of at least one light pulse sequence emitted by the emitter and then emit the light pulse sequence. The main control circuit 4 is fixed at the housing 1. In some embodiments, the main control circuit 4 may be configured to control the scan mechanism 3 to operate.

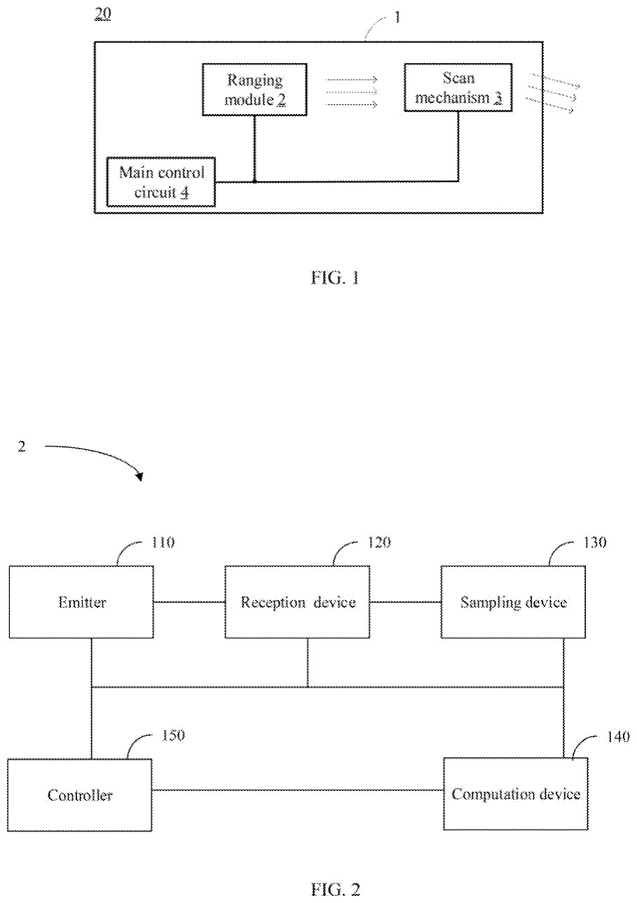

As shown in FIG. 2, the ranging module 2 includes an emitter 110, a reception device 120, a sampling device 130, and a computation device 140.

The emitter 110 may be configured to emit a light pulse sequence (e.g., a laser pulse sequence). The reception device 120 may be configured to receive the light pulse sequence reflected by the detected object, perform photoelectric conversion on the light pulse sequence to obtain an electrical signal, and output the processed electrical signal to the sampling device 130. The sampling device 130 may be configured to perform sampling on the electrical signal to obtain a sampling result. The computation device 140 may be configured to determine the distance between the ranging module 2 and the detected object based on the sampling result of the sampling device 130.

In some embodiments, the ranging module 2 further includes a control circuit 150. The control circuit 150 may be configured to control another circuit. For example, the control circuit 150 may be configured to control the operation time of the circuits and/or perform parameter setting on the circuits.

Although the ranging apparatus 20 shown in FIG. 2 includes the emitter, the reception device, the sampling device, and the computation device and is configured to emit a beam for detection, the present disclosure is not limited to this. A quantity of any one device of the emitter, the reception device, the sampling device, and the computation device may be at least two. The ranging apparatus may be configured to emit at least two beams along a same direction or different directions. The at least two beams may be emitted simultaneously or at different times. In some embodiments, light-emitting chips of the at least two emitters may be packaged in a same module. For example, each emitter may include a laser emission chip. Dies of the laser emission ships of the at least two emitters may be packaged together and accommodated in a same package space.

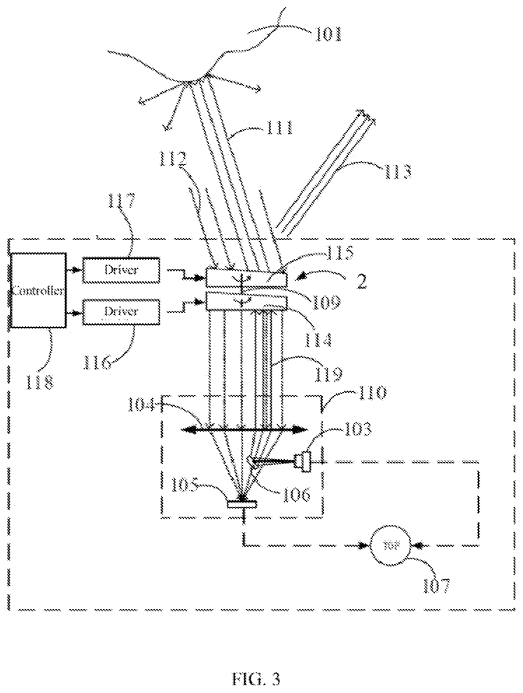

In some embodiments, a co-axial optical path may be used in the ranging module 2. That is, the beam emitted from the ranging module 2 and a beam reflected may share at least a part of the optical path in the ranging module 2. For example, the at least one beam of the light pulse sequence emitted by the emitter may be emitted after the transmission direction of the at least one beam of the light pulse sequence is changed by a scanner. The light pulse sequence reflected by the detected object may enter into the reception device through the scanner. In some other embodiments, off-axial optical paths may be used in the ranging module 2. That is, the beam emitted by the ranging module 2 and the beam reflected may be transmitted along different paths in the ranging module 2. FIG. 3 is a schematic diagram of a ranging module 2 using a coaxial optical path according to some embodiments of the present disclosure.

The ranging module 2 includes a light reception and emission device 110. The light reception and emission device 110 includes an emitter 103 (including the emission device), a collimation element 104, a detector 105 (including the reception device, the sampling device, and the computation device), and an optical path change element 106. The light reception and emission device 110 may be configured to emit a beam, receive a returned beam, and convert the returned beam into an electrical signal. The emitter 103 may be configured to emit an optical pulse sequence. In some embodiments, the emitter 103 may emit a laser beam. In some embodiments, the laser beam emitted by the emitter 103 may include a narrow bandwidth beam with a wavelength outside of a visible light range. The collimation element 104 may be arranged on an emission path of the emitter 103 and further configured to collimate the beam emitted from the emitter 103 into parallel light. The collimation element 104 may be further configured to converge at least a part of the returned beam reflected by the detected object. The collimation element 104 may include a collimation lens or another element that can collimate the beam.

In some embodiments shown in FIG. 3, an emission optical path and a reception optical path of the ranging module 2 may be combined through the optical path change element 106 before the collimation element 104. Thus, the emission optical path and the reception optical path may share the same collimation element to cause the optical path to be more compact. In some other embodiments, each of the emitter 103 and the detector 105 may include a collimation element 104. The optical path change element 106 may be arranged at the optical path after the collimation element 104.

In some embodiments shown in FIG. 3, since a diameter of a beam hole of the emitter 103 for emitting the beam is relatively small, and a diameter of a beam hole of the ranging module 2 for receiving the returned beam is relatively large, the optical path change element may use a reflection mirror with a small area to combine the emission optical path and the reception optical path. In some other embodiments, the optical path change element may also include a reflection mirror with a through-hole. The through-hole may be configured to transmit the emitted beam of the emitter 103. The reflection mirror may be configured to reflect the returned beam to the detector 105. As such, when a small reflection mirror is used, shielding of the returned beam by the holder of the small reflection mirror may be reduced.

In some embodiments shown in FIG. 3, the optical path change element 106 may be off the optical path of the collimation element 104. In some other embodiments, the optical path change element 106 may be located on the optical path of the collimation element 104.

In some embodiments, the emitter 103 may include a laser device. The laser in the nano-second level may be emitted by the laser device. For example, the laser pulse emitted by the emitter 103 may last for 10 ns. Further, the reception time of the laser pulse may be determined. For example, the reception time of the laser pulse may be determined by detecting at least one of the ascending edge time or the descending edge time of the electrical signal pulse. As such, the ranging apparatus 20 may calculate the time of flight (TOF) by using the pulse reception time information and the pulse transmission time information to determine the distance between the detected object 101 and the ranging apparatus 20.

In some embodiments, the scan mechanism 3 is arranged on an emission path of the light reception and emission device 110. The scan mechanism 3 may be configured to change the transmission direction of the collimated beam 119 emitted by the collimation element 104 and project the collimated beam 119 to the outside environment. The scan mechanism 3 may be also configured to project the returned light to the collimation element 104. The returned light may be converged to the detector 105 through the collimation element 104.

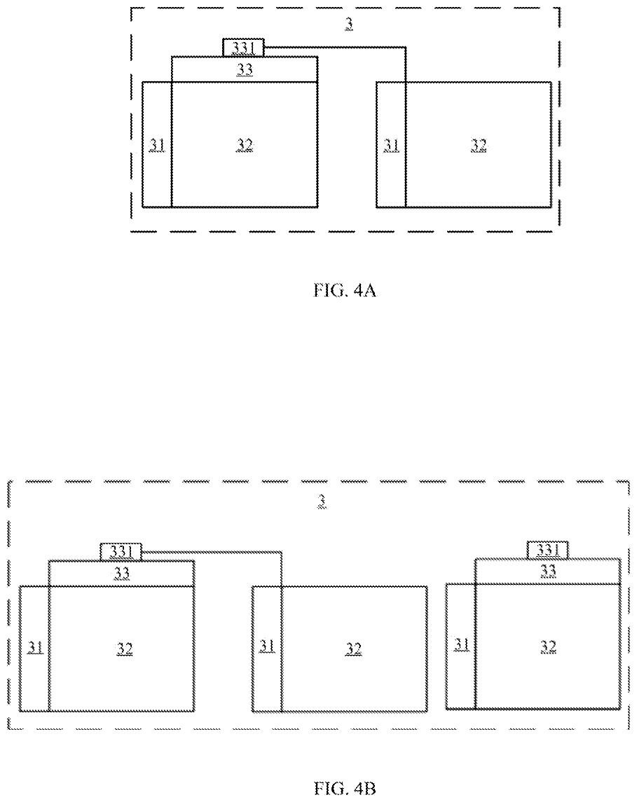

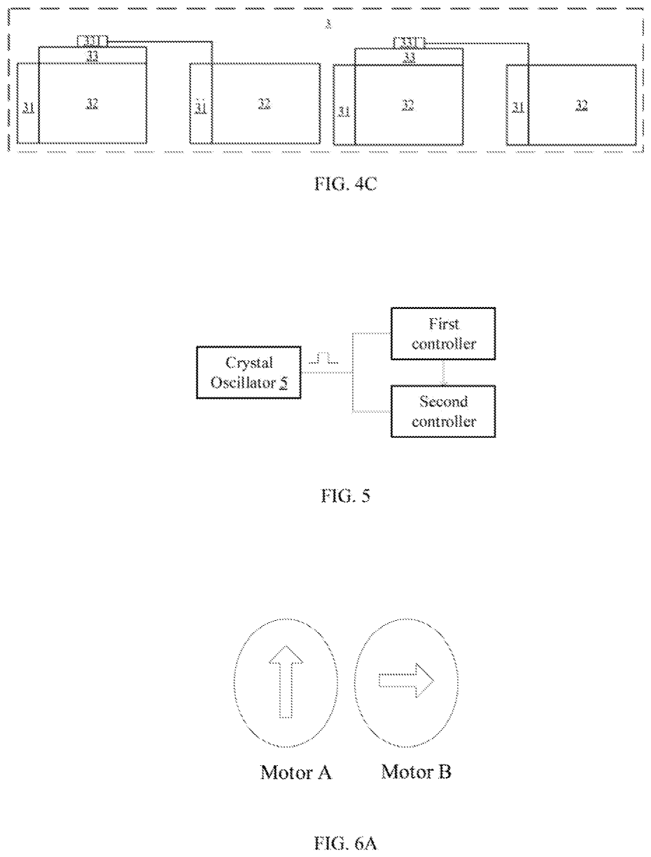

In connection with FIG. 4A, FIG. 4B, and FIG. 4C, the scan mechanism 3 of embodiments of the present disclosure includes a plurality of optical elements 31, a plurality of motors 32, and one or more controllers 331. The plurality of motors 32 may correspond to the plurality of optical elements 31. Each optical element 31 may rotate driven by a motor 32 to change the transmission path of the beam incident to the optical element 31. The motor 32 of embodiments of the present disclosure may include a hollow rotor. The optical element 31 may be arranged at the rotor of the corresponding motor 32. The beam may enter into the rotor and be emitted out of the rotor after the transmission path f the beam is changed by the optical element 31. In some embodiments, the optical element 31 may be embedded at an end of the rotor.

In some embodiments, as shown in FIG. 4A, a controller 331 is included. The controller 331 may be configured to control the plurality of motors 32. That is, all of the plurality of motors 32 in the scan mechanism 3 may be controlled by the controller 331.

In some other embodiments, as shown in FIG. 4B and FIG. 4C, a plurality of controllers 331 are included. At least one of the plurality of controllers 331 may be configured to control at least two motors 32. In some embodiments, as shown in FIG. 4B, some motors 32 may be controlled by independent controllers 331. Another part of motors may be divided into at least a group of motors. Each group of motors may be controlled by a shared controller 331. For example, the scan mechanism 3 includes motor 1, motor 2, and motor 3. Motor 1 is controlled by controller 1, and motor 2 and motor 3 are controlled by controller 2. In some embodiments, as shown in FIG. 4C, the plurality of motors may be divided into at least a group of motors. Each group of motors are controlled by a shared controller. Each group of motors may include at least two motors. For example, the scan mechanism 3 includes 4 motors such as motor 1, motor 2, motor 3, and motor 4. Motor 1 and motor 2 are controlled by controller 1, and motor 3 and motor 4 are controlled by controller 2.

In some embodiments, when one controller 331 controls at least two motors 32, the controller 331 may control at least two motors 32 to rotate at a predetermined angle difference based on a first synchronization control strategy. When one controller 331 controls one motor 32, the controller 331 may control the motor 32 with another at least one motor 32 to rotate at the predetermined angle difference based on a second synchronization control strategy. The plurality of motors 32 may be controlled to rotate at the predetermined angle difference by using different control strategies to synchronize the plurality of motors 32. Thus, fluctuation of angle differences among the plurality of optical elements 32 may be reduced, and the ranging apparatus 20 may generate a scan trajectory with a determined angle.

When the controller 331 controls three or more motors 32, a predetermined angle difference of each two motors 32 may be same or different. The predetermined angle difference of each two motors 32 may be set as needed.

The first synchronization control strategy may include that the controller 331 may obtain a real-time rotation angle of each motor 32 and correct the position of each motor 32 according to the real-time rotation angle of each motor 32 and a predetermined target rotation speed of each motor 32. The rotation of at least two motors 32 may be controlled by a controller 331 to reduce the rotation fluctuation of each motor 32. Thus, each two motors 32 may rotate at the predetermined angle difference. Thus, the motor 32 may be accurately controlled to increase the accuracy of the scan trajectory. The advantage of using one controller 331 to control the at least two motors 32 includes that the positions of the at least two motors 32 may be sampled and controlled simultaneously to facilitate adjustment of the rotations of the at least two motors 32 according to the angle.

The real-time rotation angle of the motor 32 may be determined based on the motor control signal transmitted by the controller 331, which controls the motor 32, to the motor 32. Determining the real-time rotation angle of the motor 32 based on the motor control signal is the existing technology, which is not detailed in the present disclosure.

In some embodiments, the controller 331 controlling each motor 32 to rotate according to the real-time rotation angle of each motor 32 and the predetermined target rotation speed of each motor 32 includes determining the target angle of each motor 32 according to the predetermined target speed of each motor 32, determining an angle error of each motor 32 according to the real-time rotation angle of each motor 32 and the target angle of the motor 32, and correcting the position of the motor 32 according to the angle error of each motor 32.

When satisfying a first trigger condition, the controller 331 of embodiments of the present disclosure may perform correction on the position of each motor 32. In some embodiments, the first trigger condition may include a predetermined time interval. The controller 331 may perform correction on the position of each motor 32 after the predetermined time interval. For example, the controller 331 may perform the correction on the position of each motor 32 at time t₁, and the controller 331 may perform the correction on the position of each motor 32 at time t₂=t₁+Δt next time. In some embodiments, the target angle of each motor 32 may be determined according to the predetermined target rotation speed of the motor 32, the predetermined time interval, and the real-time rotation angle of the motor 32 when the position is corrected last time.

In some embodiments, during the operation of the motor 32, two motors A and B may operate in a position closed-loop mode. Assume that a target rotation speed of motor A is vₐ and a rotation speed of motor B is v_{b}. A same controller 331 may be used to perform position control on the two motors A and B. At time t₁, the controller 331 may determine an angle of the motor A to be θ₁ₐ based on a motor control signal transmitted by the controller 331 to motor A and an angle of motor B to be θ_{1b} based on a motor control signal transmitted by the controller 331 to the motor B. The controller 331 may start to perform position correction on the two motors A and B at time t₁. A control cycle of performing the position correction may be Δt. Time for performing a next position correction may be t₂=t₁+Δt. At time t₂, the controller 331 may determine the angle of motor A to be θ₂ₐ based on the motor control signal transmitted by the controller 331 to the motor A and the angle of motor B to be θ_{2b} based on the motor control signal transmitted by the controller 31 to motor B. At time t₂, according to the determined target rotation speed, the target angle θ₂ₐ′ of motor A and the target angle θ_{2b}′ of motor B include:

$$\{ \begin{matrix}{θ}_{2 a}^{′} = {θ}_{1 a} + {v}_{a} * Δ t \\ {θ}_{2 b}^{′} = {θ}_{1 b} + {v}_{b} * Δ t\end{matrix} \qquad ( 1 )$$

Thus, at time t₂, an angle error Δθₐ of motor A and an angle error Δθ_{b} of motor B include:

$$\{ \begin{matrix}Δ {θ}_{a} = {θ}_{2 a}^{′} - {θ}_{2 a} \\ Δ {θ}_{b} = {θ}_{2 b}^{′} - {θ}_{2 b}\end{matrix} \qquad ( 2 )$$

After determining the angle error Δθₐ of motor A and the angle error Δθ_{b} of motor B, the controller 331 may perform correction on the angle errors of motor A and motor B by using proportional-integral-derivative (PID) or another control algorithm to realize the position closed-loop control of the two motors A and B.

The second synchronization control strategy may include that one of the controller and another controller of at least one motor may be used as a main controller, the other one may be used as a secondary controller. The main controller may be configured to transmit the trigger signal to the secondary controller to adjust a control parameter (e.g., the rotation speed of the motor) of the secondary controller based on the second trigger condition. The trigger signal may include a pulse flip signal or another signal.

In some embodiments, when determining that the real-time rotation angle of the motor that is controlled by the main controller is a first angle, the main controller may transmit the trigger signal to the secondary controller. The second trigger condition may be set to otherwise, for example, the real-time rotation angle of the motor controlled by the main controller is in a predetermined angle range.

When the secondary controller receives the trigger signal, the secondary controller may adjust the control parameter of the secondary controller according to the real-time angle of the motor controlled by the secondary controller and a predetermined strategy to adjust the rotation angle of the motor controlled by the secondary controller. Thus, the motor controlled by the secondary controller and the motor controlled by the main controller may rotate at the predetermined angle difference. In some embodiments, the secondary controller may adjust the rotation angle of the motor controlled by the secondary controller according to the real-time angle of the motor controlled by the secondary controller, the real-time rotation angle of the motor controlled by the main controller based on the trigger condition, and the predetermined angle difference.

The real-time angle of the motor controlled by the secondary controller may be determined based on the motor control signal transmitted by the secondary controller. Based on the above description, determining the real-time rotation angle of the motor is the existing technology.

In some embodiments, as shown in FIG. 5, a controller as an electronic speed control (ESC) includes a first controller and a second controller. Assume that the first controller may control motor A, and the second controller may control motor B. Motor A may be set as a main motor, and motor B may be set as a secondary motor. Correspondingly, the first controller may be used as the main controller, and the second controller may be used as the secondary controller. The first controller and the second controller may be connected via a synchronization signal wire for communication. When motor A rotates to angle x (the first controller may determine the real-time rotation angle of motor A based on the motor control signal transmitted by the first controller to motor A), the first controller may transmit the pulse flip signal to the second controller via the synchronization signal wire. When the second controller receives the pulse flip signal, the real-time rotation angle of motor B may be determined to be angle y based on the motor control signal transmitted by the second controller to motor B. By adjusting the angle of the motor B, the angle difference between motor A and motor B may be kept at the predetermined angle difference.

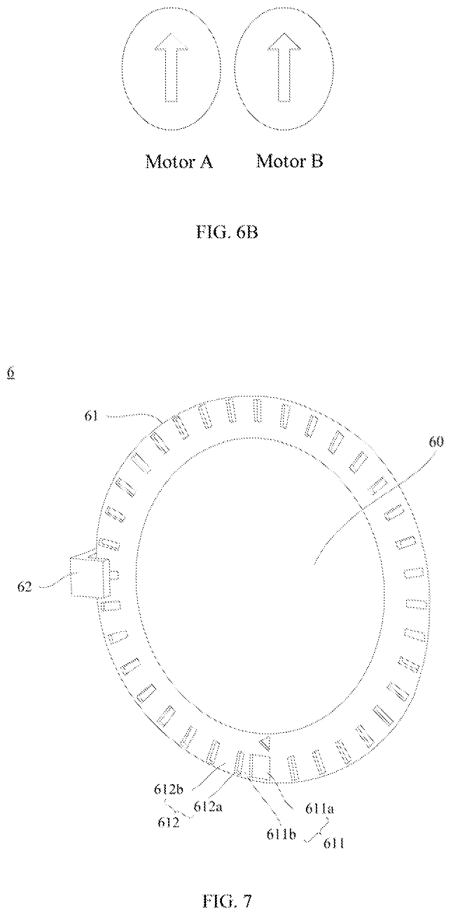

Motor A and motor B may be set to rotate to arrows (e.g., arrows in FIG. 6A and FIG. 6B). Vertical upward includes angle 0. The predetermined angle difference between motor A and motor B is 0°. That is, the target angles of motor A and motor B are the same. Assume that motor A may rotate clockwise, and motor B may rotate counterclockwise. When the first controller detects that motor A rotates to 0° (e.g., the position of motor A shown in FIG. 6A), the first controller may transmit the pulse flip signal to the second controller to trigger the second controller to perform correction on the position of motor B. When the second controller receives the pulse flip signal and detects that motor B rotates to 90°, the angle difference between motor A and motor B may be 90°. To cause the target angles of motor A and motor B to be the same, that is, motor A and motor B need to be at the positions of motor A and motor B shown in FIG. 6B simultaneously, the second controller may adjust the control parameter to rotate motor B 90° counterclockwise. That is, the position of motor B may be increased for 900 counterclockwise to ensure that when motor A is at 0°, motor B may also be at 0°.

In some embodiments, each time the first controller detects that motor A rotates to 0°, the second controller may be triggered to perform the correction on the position of motor B to ensure that the positions of motor A and motor B to be always synchronized.

During the operation, the rotations of motor A and motor B may be controlled by using the first synchronization control strategy to further ensure the positions of motor A and motor B to be synchronized.

Further, the scan mechanism 3 of embodiments of the present disclosure may further include a clock source module. The clock source module may communicate with the main controller and the secondary controller. The clock source module may generate and transmit a clock signal to the main controller and the secondary controller to cause the main controller and the secondary controller to realize time synchronization. In some embodiments, the clock signal may include a pulse signal. After the main controller and the secondary controller receive the clock signal, time clearing may be performed on an ascending edge or a descending edge of the clock signal to ensure the time synchronization of the main controller and the secondary controller.

In some embodiments, as shown in FIG. 5, the clock source module includes a crystal oscillator 5. The crystal oscillator 5 may generate and transmit the clock signal to the main controller and the secondary controller to cause the main controller and the secondary controller to realize the time synchronization. In some other embodiments, the main controller 4 may include a function of the clock source module. That is, the main controller 4 may be used as the clock source module. In some embodiments, the main controller 4 may generate and transmit the clock signal to the main controller and the secondary controller to cause the main controller and the secondary controller to realize the time synchronization. The clock source module may not be limited to the crystal oscillator 5 and the main controller 4 and may include another structure that can generate a clock signal.

In addition, the motor 32 of embodiments of the present disclosure may include a brushless motor. In the ranging apparatus 20, the light emission device, the light reception device, and the main control device may be arranged at the rotor of the motor 32 and may rotate with the rotor of the motor 32. During rotation, power and signal transmission may need to be provided to the light emission device, the light reception device, and the main control device. Therefore, the motor 32 may need to be designed with a complex brush structure to transmit power and signal. In some embodiments, only the optical element 31 may be arranged at the rotor. No electronic device is arranged at the rotor. Thus, the brushless motor may be used, which greatly reduces the complexity of the scan mechanism 3 and improves the reliability.

Further, the scan mechanism 3 further includes an ESC 33. A quantity of the ESCs 33 may be equal to a quantity of the controllers. The controller of embodiments of the present disclosure may be arranged at the corresponding ESC 33. For example, when one controller is included, one ESC 33 may be included, and the controller may be arranged at the ESC 33. When two controllers are included, two ESC 33 may be included, and the two controllers may be arranged correspondingly at the two ESCs 33.

The ESC 33 of embodiments of the present disclosure may be fixed at the housing of the motor 32 controlled by the corresponding controller 331 (i.e., the controller 331 arranged at the ESC 33). In some embodiments, the motor may include a stator. The stator may be fixedly connected to an outer shell. The outer shell may be fixedly connected to housing 1. The ESC 33 may not rotate as the rotor rotates.

Further, the ESC 33 may include a control interface. The rotor may include a control end. The control interface of the ESC 33 may be arranged adjacent to the control end of the rotor of the corresponding motor 32. The control interface may be connected to the corresponding control end via a conductive wire. The conductive wire may include a three-phase wire, which may transmit a relatively large current. In some embodiments, the control interface of the ESC 33 may be arranged adjacently to the control end of the rotor of the corresponding motor 32 to shorten the length of the three-phase wire between the control interface and the corresponding control end to reduce the voltage of the three-phase wire and wire loss. Thus, the efficiency of the motor 32 may be increased.

In some embodiments, the scan mechanism 3 may include one or more optical elements 31, which may be configured to change the transmission direction of the beam. For example, the scan mechanism 3 may include a lens, a reflection mirror, a prism, a galvanometer, a grating, a liquid crystal, an optical phased array, or any combination thereof. In some embodiments, as shown in FIG. 3, a plurality of optical elements 31 of the scan mechanism 3 may rotate or vibrate around a shared axis 109. Each rotating or vibrating optical element 31 may be configured to continuously change a transmission direction of an incident beam. In some embodiments, the plurality of optical elements of the scan mechanism 3 may rotate at different rotation speeds or vibrate at different speeds. In some other embodiments, at least the part of the optical elements 31 of the scan mechanism 3 may rotate at a nearly same rotation speed. In some other embodiments, the plurality of optical elements 31 of the scan module may rotate around different rotation axes. In some other embodiments, the plurality of optical elements 31 of the scan module may rotate in a same direction or in different directions, or vibrate in a same direction or different directions, which is not limited here.

In some embodiments, the optical element 31 includes a first optical element 114 and a driver 116 (i.e., motor 32) connected to the first optical element 114. The driver 116 may be configured to drive the first optical element 114 to rotate around the rotation axis 109 to cause the first optical element 114 to change the direction of the collimated beam 119. The first optical element 114 may project the collimated beam 119 in different directions. In some embodiments, an included angle between the direction of the collimated beam 119 after the first optical element and the rotation axis 109 may change as the first optical element 114 rotates. In some embodiments, the first optical element 114 includes a pair of opposite surfaces that are not parallel. The collimated beam 119 may pass through the pair of surfaces. In some embodiments, the first optical element 114 may include at least a lens, whose thickness changes along a radial direction. In some embodiments, the first optical element 114 may include a wedge prism, which may be configured to refract the collimated beam 119.

In some embodiments, the optical element 31 further includes a second optical element 115. The second optical element 115 may rotate around the rotation axis 109. The second optical element 115 and the first optical element 114 may have different rotation speeds. The second optical element 115 may be configured to change the direction of the beam projected by the first optical element 114. In some embodiments, the second optical element 115 may be connected to another driver 117 (i.e., motor 32). The driver 117 may be configured to drive the second optical element 115 to rotate. The first optical element 114 and the second optical element 115 may be driven by the same driver or different drivers to cause the rotation speeds and/or the rotation directions of the first optical element 114 and the second optical element 115 to be different. Thus, the collimated beam 119 may be projected to different directions of external space to scan a relatively large space area. In some embodiments, a controller 118 may be configured to control the drivers 116 and 117 to drive the first optical element 114 and the second optical element 115, respectively. The rotation speeds of the first optical element 114 and the second optical element 115 may be determined according to an expected scan area and style in practical applications.

In some embodiments, the second optical element 115 may include a pair of opposite surfaces that are not parallel. The beam may pass through the pair of surfaces. In some embodiments, the second optical element 115 may include at least a lens whose thickness changes along a radial direction. In some embodiments, the second optical element 115 may include a wedge prism.

In some embodiments, the optical element 31 may further include a third optical element (not shown in the figure) and a driver (i.e., motor 32) for driving the third optical element. In some embodiments, the third optical element may include a pair of opposite surfaces that are not parallel. The beam may pass through the pair of surfaces. In some embodiments, the third optical element may include at least a lens whose thickness changes along a radial direction. In some embodiments, the second optical element 115 may include a wedge prism. At least two of the first optical element, the second optical element, and the third optical element may rotate at different rotation speeds and/or in different directions.

The optical elements of the scan mechanism 3 may rotate to project light to different directions, for example, directions 111 and 113. As such, the scam mechanism 3 may scan the space around the ranging module 2. When the projected light 111 of the scan mechanism 3 encounters the detected object 101, a part of the light may be reflected by the detected object 101 along an opposite direction to the direction of the projected light 111 to the ranging module 2. The returned light 112 reflected by the detected object 101 may be incident to the collimation element 104 after passing through the scan mechanism 3.

The detector 105 and the emitter 103 may be arranged at a same side of the collimation element 104. The detector 105 may be configured to convert at least the part of the returned light that passes through the collimation element 104 into an electrical signal.

In some embodiments, the optical elements may be coated with an anti-reflection film. The thickness of the anti-reflection film may be equal to or close to a wavelength of the beam emitted by the emitter 103. The anti-reflection film may increase the intensity of the transmitted beam.

In some embodiments, a filter layer may be coated on a surface of an element of the ranging module 2 in the transmission path of the beam, or a filter may be arranged in the transmission path of the beam, which may be configured to transmit the light with a wavelength within the wavelength band of the beam emitted by the emitter and reflect the light of another wavelength band. Thus, the noise caused by environmental light may be reduced for the receiver.

In some embodiments, the controller 331 may control the angle and rotation speed of the motor 32. The related control parameter, such as the angles of the motors 32, the predetermined angle difference between two motors 32, and the rotation speeds of the motors 32, may be set by the main control circuit 4. In some embodiments, the controller 331 may be communicatively connected to the main control circuit 4 through a serial port. The main control circuit 4 may obtain or set the control parameter of the controller 331 through the serial port. The signal transmission quality between the main control circuit 4 and the controller 331 may be effectively improved through the serial port connection.

In connection with FIG. 4A to FIG. 4C, the ranging apparatus 20 of embodiments of the present disclosure further includes a plurality of position detection devices 6. The plurality of position detection devices 6 may correspond to the plurality of optical elements 31. The plurality of position detection devices 6 may directly be electrically coupled to the main control circuit 4. The main control circuit 4 of embodiments of the present disclosure may determine the rotation position of the corresponding optical element 31 according to the collected data of the plurality of position detection devices 6. The main control circuit 4 may determine the operation status of the corresponding motor 32 according to the rotation position f each optical element 31. In some embodiments, the position detection device 6 may directly be electrically coupled to the main control circuit 4, which separates the motor control and motor angle measurement. Thus, the wiring between the main control circuit 4 and the controller 331 may be simplified, which improves the stability of the communication between the main control circuit 4 and the controller 331 and solves a problem of electromagnetic interference (EMI). The motor control and the motor angle measurement may be separated, which avoids the problem of mutual interference. Therefore, the problem of failure of the main control circuit 4 due to the abnormality of the motor is fundamentally avoided, and higher robustness is achieved.

In addition, the main control circuit 4 may be further configured to construct a reliable self-checking network based on angle measurement to ensure the operating status of the whole device. In some embodiments, when determining the corresponding motor 32 to be in an abnormal status according to the rotation position of the optical element 31, the main control circuit 4 may close the ranging module 2 or the ranging apparatus 20. That is, when the control of the motor 32 is failed, the operation of the apparatus needs to be stopped in time, such as stopping the ranging module 2 to emit the beam to ensure safety. In some embodiments, the main control circuit 4 may measure at least one of the motor angle or the rotation speed of the motor through the position detection device 6. The main control circuit 4 may detect whether the control of the motor 32 is normal according to at least one of the motor angle or the rotation speed of the motor.

The structure of the position detection device 6 may be designed as needed. For example, in some embodiments, the position detection device 6 may include a measurement module. As shown in FIG. 7, the measurement module includes an encoder disc 61 having an opening 60 and at least one light switch 62. The opening 60 may be configured to be sleeved at the rotor of the corresponding motor 32. In some embodiments, the at least one light switch 62 may directly be electrically coupled to the main control circuit 4. The at least one light switch 62 may cooperate with the encoder disc 61 to detect the rotation position of the corresponding motor 32.

As shown in FIG. 7, a same circumference of the encoder disc 61 is divided equally into a plurality of continuous detection groups. The plurality of detection groups include a first detection group 611 and a plurality of second detection groups 612. The first detection group 611 includes a first light transmission area 611a and a first non-light transmission area 611b. Each of the plurality of second detection groups 612 includes a second light transmission area 612a and a second non-light transmission area 612b. In some embodiments, a width of the first light transmission area 611a may be different from a width of the second light transmission area 612a. Since the plurality of continuous detection groups are distributed equally along the same circumference of the encoder disc 61, a sum of the width of the first light transmission area 611a and a with of the first non-light transmission area 611b may be equal to a sum of the width of the second light transmission area 612a and a width of the second non-light transmission area 612b. Therefore, the width of the first non-light transmission area 611b may also be different from the width of the second non-light transmission area 612b. In some embodiments, the width may include a circumferential width along the circumference of the encoder disc 61.

In some embodiments, the width of the first light transmission area 611a may be three times the width of the second light transmission area 612a. The width of the second non-light transmission area 612b may be three times the width of the second non-light transmission area 612a. In some other embodiments, the widths of the first light transmission area 611a, the second light transmission area 612a, the first non-light transmission area 611b, and the second non-light transmission area 612b may be set to other sizes.

In addition, a quantity of the second detection groups 612 may be set as needed, such as the quantity of the second detection groups 612 may include 35, 71, or another number.

The first light transmission area 611a and the second light transmission area 612a may include through-holes or light transmission areas of other shapes.

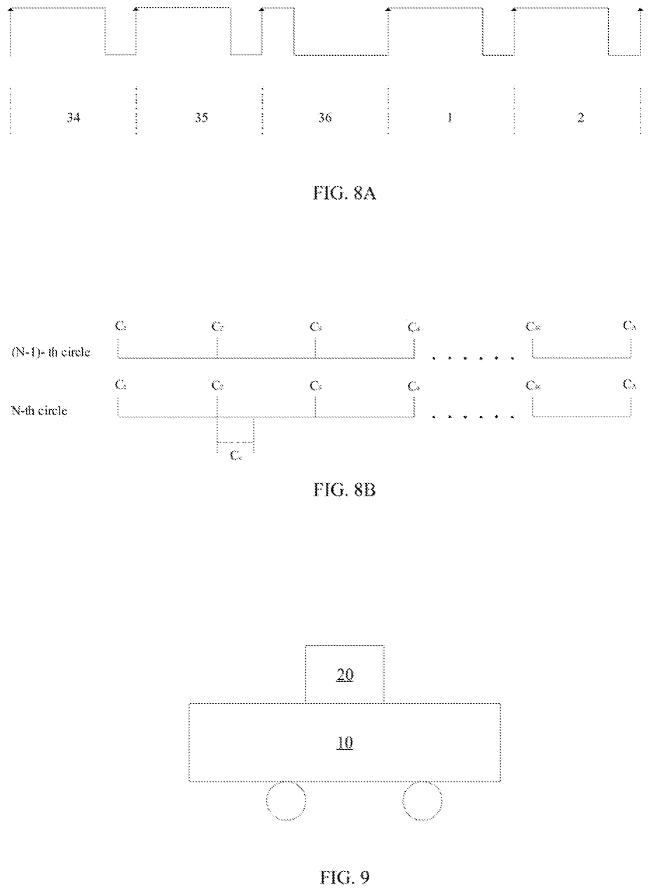

One or two light switches 62 may be included. Taking that one light switch 62 is included as an example, in some embodiments, during the rotation of the motor 32, the light switch 62 may cooperate with the detection group. The light switch 62 outputs a pulse sequence as shown in FIG. 8A. The light switch 62 may transmit the pulse sequence to the main control circuit 4. The main control circuit 4 may determine the rotation position of the corresponding optical element 31 according to the pulse sequence.

In some embodiments, a specific area of the first light transmission area 611a may correspond to a zero position of the optical element 31. Taking that the encoder disc 61 rotates counterclockwise with the rotor as an example, FIG. 7 shows a position relationship between the light switch 62 and the encoder disc 61. The first specific area may include a position of the first light transmission area 611a that passes through the light switch 62 at first. The first specific area may also include a position of the first light transmission area 611a that passes through the light switch 62 at last. In some other embodiments, the first specific area may be between the position of the first light transmission area 611a that passes through the light switch 62 at first and the position of the first light transmission area 612a that passes through the light switch 62 at last.

A time length between ascending edges of the pulse corresponding to two neighboring second light transmission areas 612a of the encoder disc 61, a time length between descending edges of the pulse corresponding to two neighboring second light transmission areas 612a, a time length between ascending edges of the pulse corresponding to two neighboring second non-light transmission areas 612b, or a time length between descending edges of the pulse corresponding to the two neighboring second non-light transmission areas 612b may represent a complete signal cycle.

Mechanical processing of the encoder disc 61 may have a certain error, which may cause the widths of the detection groups to be not even enough. To correct the mechanical processing error, when determining the rotation position of the motor 32 according to the pulse sequence, the main control circuit 4 may correct the position detection error caused by the mechanical processing error through an algorithm.

The main control circuit 4 may perform the following processes on the pulse sequence. In the pulse sequence, a quantity X of the complete signal cycles may be determined between the current time and the time when one of the at least light switches 62 last detects the specific area, and a time interval Cc_{(N)} between the current time and the time when the last complete signal cycle ends may be determined. A first time length CA_{(N-1)} and a second time length CX_{(N-1)} may be determined according to the pulse sequence. The first time length CA_{(N-1)} may include a time interval between when the one of the at least one light switches 62 detects the specific area the last time and the latest time. The second time length CX_{(N-1)} may include a time interval between the start position of the signal cycle, when the current time is, detected by the one of the at least one light switches 62 the last time and when the one of the at least one light switches 62 detects the specific area the last time. According to the time interval Cc_{(N)} between the current time and the time when the last complete signal cycle ends, the first time length CA_{(N-1)}, and the second time length CX_{(N-1)}, the rotation position of the optical element 31 may be determined.

In some embodiments, when the main control circuit 4 detects the zero position based on the pulse sequence, a register 1 may start to count from zero to record a start count number C₁, C₂, . . . , C₃₆ of each of the plurality of detection groups and a total count number C_{A} when the encoder disc 61 rotates for a circle, where C₁=0, and C₁<C₂< . . . <C₃₆<C_{A}. when the encoder disc 61 rotates to an N-th circle, a start angle may be calculated for each of the plurality of detection groups by using information of an (N−1)-th circle (last circle). The start angle may be used to correct the mechanical processing error. When the main control circuit 4 detects that a next detection group arrives based on the pulse sequence of the N-th circle, the register 2 may start to count from zero. When sampling is triggered, a sign X of the current detection group and the count number Cc_{(N)} of the register 2 may be recorded. Cc_{(N)} may be used to calculate the angle in the current detection group.

A calculation formula of the rotation position of the optical element 31 includes (CX_{(N-1)}+Cc_{(N)})/C_{A(N-1)}*360. An angle detection accuracy may be 0.01°. A subscript (N-1) denotes information when the encoder disc 61 rotates to an (N−1)-th circle. A subscript (N) denotes information when the encoder disc 61 rotates to an N-th circle.

In embodiments shown in FIG. 8B, the rotation position of the optical element 31 includes (C_{2(N-1)}+Cc_{(N)})/C_{A(N-1)}*360.

The structure of the position detection device 6 is not limited to the structures described above. Another structure that can detect the angle may be selected.

The ranging apparatus 20 may include a radar ranging apparatus (e.g., LIDAR), a laser ranging apparatus, etc. In some embodiments, the ranging apparatus 20 may be configured to sense external environment information, for example, distance information of an environment target, orientation information, reflection intensity information, speed information, etc. In some embodiments, the ranging apparatus 20 may be configured to detect a distance from a detected object to the ranging apparatus 20 by measuring light transmission time, i.e., time-of-flight (TOF), between the ranging apparatus 20 and the detected object. In some other embodiments, the ranging apparatus 20 may be configured to detect the distance from the detected object to the ranging apparatus 20 through another technology, for example, a ranging method based on phase shift measurement or frequency shift measurement, which is not limited here.

The distance and orientation detected by the ranging apparatus 20 may be used for remote sensing, obstacle avoidance, surveying and mapping, modeling, navigation, etc. In some embodiments, the ranging apparatus 20 of embodiments of the present disclosure may be applied to a mobile platform. As shown in FIG. 9, the ranging apparatus 20 is mounted at a platform body 10 of the mobile platform. The mobile platform having the ranging apparatus 20 may perform measurement on the external environment. For example, a distance between the mobile platform and an obstacle may be measured to avoid the obstacle, and 2-dimensional and 3-dimensional surveying and mapping may be performed on the external environment.

In some embodiments, the mobile platform may include at least one of an unmanned aerial vehicle (UAV), a vehicle (including a car), a remote vehicle, a ship, a robot, or a camera. When the ranging apparatus 20 is applied to the UAV, the platform body may be a vehicle body of the UAV. When the ranging apparatus 20 is applied to the car, the platform body may be a body of the car. The car may include an auto-pilot car or a semi-auto-pilot car, which is not limited here. When the ranging apparatus 20 is applied to the remote vehicle, the platform body may be the vehicle body of the remote vehicle. When the ranging apparatus 20 is applied to the robot, the platform body may be the robot. When the ranging apparatus 20 is applied to the camera, the platform body may be a camera body.

When one controller controls one motor 32, one of the controller and a controller of another at least one motor 32 may be used as the main controller, and the other one may be used as the secondary controller. The ranging apparatus of embodiments corresponding to the one controller controlling the one motor 32, embodiments of the present disclosure further provided a ranging apparatus and a control method. Control methods of using the main controller and the secondary controller as an execution body for the ranging apparatus are described below.

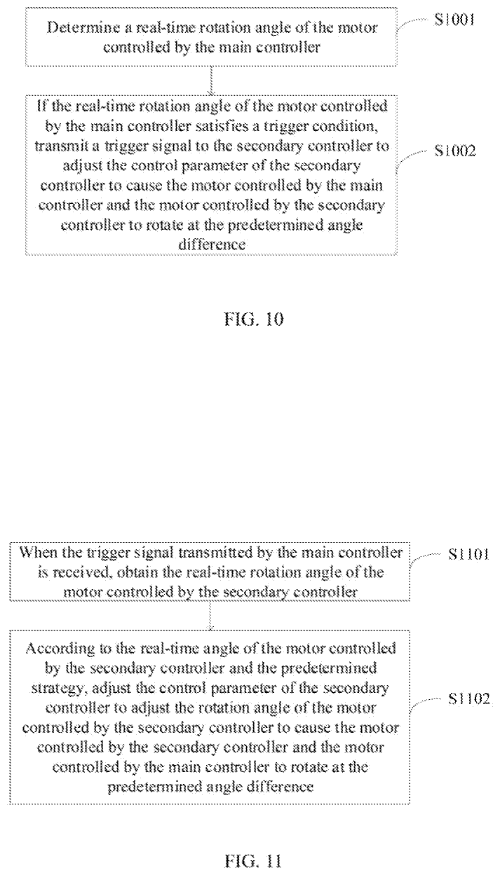

FIG. 10 is a schematic flowchart of a control method of the ranging apparatus on the main controller side according to some embodiments of the present disclosure. The ranging apparatus 20 of embodiments of the present disclosure may include the main controller and the secondary controller. The main controller and the secondary controller may be configured to control motors. The structure of the ranging apparatus 20 may be referred to the description above, which is not repeated here. As shown in FIG. 10, the control method of the ranging apparatus includes the following processes.

At S1001, a real-time rotation angle of the motor controlled by the main controller is determined.

In some embodiments, the real-time rotation angle of the motor controlled by the main controller may be determined based on the motor control signal transmitted by the main controller.

At S1002, if the real-time rotation angle of the motor controlled by the main controller satisfies a trigger condition, a trigger signal is transmitted to the secondary controller to adjust the control parameter of the secondary controller to cause the motor controlled by the main controller and the motor controlled by the secondary controller to rotate at the predetermined angle difference.

In some embodiments, determining that the real-time rotation angle of the motor controlled by the main controller satisfies a second trigger condition includes determine the real-time rotation angle of the motor controlled by the main controller to be a first angle.

In some embodiments, the control method of the ranging apparatus may further include receiving a clock signal and performing time synchronization according to the clock signal.

In some embodiments, the clock signal may be generated by the crystal oscillator 5 or the main control circuit 4 of the ranging apparatus.

The control method of the ranging apparatus of embodiments of the present disclosure may be described with reference to related parts above.

FIG. 11 is a schematic flowchart of a control method of the ranging apparatus on a secondary controller side according to some embodiments of the present disclosure. The ranging apparatus 20 of embodiments of the present disclosure may include the main controller and the secondary controller. The main controller and the secondary controller may control the motors. The structure of the ranging apparatus 20 is described above, which is not repeated here. As shown in FIG. 11, the control method of the ranging apparatus includes the following processes.

At S1101, when the trigger signal transmitted by the main controller is received, the real-time rotation angle of the motor controlled by the secondary controller is obtained.

In some embodiments, the real-time rotation angle of the motor controlled by the secondary controller may be determined based on the motor control signal transmitted by the secondary controller.

At Si 102, according to the real-time angle of the motor controlled by the secondary controller and the predetermined strategy, the control parameter of the secondary controller is adjusted to adjust the rotation angle of the motor controlled by the secondary controller to cause the motor controlled by the secondary controller and the motor controlled by the main controller to rotate at the predetermined angle difference.

In some embodiments, according to the real-time angle of the motor controlled by the secondary controller and the predetermined strategy, adjusting the control parameter of the secondary controller includes according to the real-time angle of the motor controlled by the secondary controller, the first angle, and the target angle difference, adjusting the control parameter of the secondary controller.

In some embodiments, the control method of the ranging apparatus further includes receiving the clock signal and performing the time synchronization according to the clock signal.

In some embodiments, the clock signal may be generated by the crystal oscillator 5 or the main control circuit 4 of the ranging apparatus.

The control method of the ranging apparatus of embodiments of the present disclosure may be described with reference to the related part above.

In the specification of the present disclosure, relational terms such as first and second are only used to distinguish one entity or operation from another entity or operation, and do not necessarily require or imply that there is any such actual relationship or sequence between these entities or operations. The terms “include,” “contain,” or any other variations thereof are intended to cover non-exclusive inclusion, so that a process, method, article, or device that includes a series of elements includes not only those elements, but also include other elements that are not explicitly listed, or also include elements inherent to such process, method, article, or device. If there are no more restrictions, the element defined by the sentence “including a . . . ”. does not exclude the existence of another same element in the process, method, article, or equipment that includes the element.

The ranging apparatus and the scanning mechanism thereof and the control method of embodiments of the present disclosure are described in detail above. Specific examples are used in the specification to illustrate the principle and implementation of the present disclosure. The description of above embodiments is only used to help understand the method of the present disclosure and its core idea. At the same time, for those of ordinary skill in the art, according to the idea of the present disclosure, there will be changes in the specific implementation and the application range. In summary, the content of the specification should not be construed as a limitation of the present disclosure.

What is claimed is:

1. A scan mechanism of a ranging apparatus comprising:
a plurality of optical elements;
a plurality of motors corresponding to the plurality of optical elements, a motor including a hollow rotor, and an optical element being arranged at the rotor of a corresponding motor; and
a controller controlling the plurality of motors, or a plurality of controllers, at least one of the plurality of controllers controlling at least two of the plurality of motors;
wherein:
in response to one controller controlling at least two motors, the controller controls the at least two motors to rotate at a predetermined angle difference based on a first synchronization strategy; and
in response to one controller controlling one motor, the controller controls the motor and another at least one motor to rotate at the predetermined angle difference based on a second synchronization strategy.

2. The scan mechanism of claim 1, wherein the first synchronization strategy includes:
the controller obtaining a real-time rotation angle of each of the plurality of motors, and performing correction on a position of each of the plurality of motors according to the real-time rotation angle of each of the plurality of motors and a predetermined target rotation speed of each of the plurality of motors.

3. The scan mechanism of claim 2, wherein:
the controller determines a target angle of each of the plurality of motors according to the predetermined target rotation speed;
the controller determines an angle error of the motor according to the real-time rotation angle of each of the plurality of motors and the target angle of the motor; and
the controller performs correction on a position of the motor according to the angle error of each of the plurality of motors.

4. The scan mechanism of claim 3, wherein the controller performs the correction on the position of each of the plurality of motors based on a first trigger condition.

5. The scan mechanism of claim 4, wherein the first trigger condition includes a predetermined time interval, the controller performing the correction on the position of each of the plurality of motors after the predetermined time interval.

6. The scan mechanism of claim 4, wherein the target angle of each of the plurality of motors is determined according to the target rotation speed of the motor, a predetermined time interval, and a real-time rotation angle of the motor when the controller performed the correction last time.

7. The scan mechanism of claim 1, wherein the second synchronization strategy includes:
using one of the controller and another controller of the at least one motor as a main controller;
using the other one of the controller and the another controller of the at least one motor as a secondary controller; and
the main controller transmitting a trigger signal to the secondary controller based on the second trigger condition to adjust a control parameter of the secondary controller.

8. The scan mechanism of claim 7, wherein:
in response to determining a real-time rotation angle of a motor controlled by the main controller to be a first angle, the main controller transmits the trigger signal to the secondary controller.

9. The scan mechanism of claim 7, wherein:
in response to receiving the trigger signal, according to a real-time angle of a motor controlled by the secondary controller and a predetermined strategy, the secondary controller adjusts a control parameter of the secondary controller to adjust a rotation angle of the motor controlled by the secondary controller to cause the motor controlled by the secondary controller and a motor controlled by the main controller to rotate at the predetermined angle difference.

10. The scan mechanism of claim 9, wherein:
according to the real-time angle of the motor controlled by the secondary controller, the real-time rotation angle of the motor controlled by the main controller based on the trigger condition, and the predetermined angle difference, the secondary controller adjusts the rotation angle of the motor controlled by the secondary controller.

11. The scan mechanism of claim 2, wherein the real-time rotation angle of the motor is determined based on a motor control signal transmitted by the controller that controls the motor to the motor.

12. The scan mechanism of claim 7, wherein:
the scan mechanism further includes a clock source module communicating with the main controller and the secondary controller; and
the clock source module generates and transmits a clock signal to the main controller and the secondary controller to cause the main controller and the secondary controller to realize time synchronization.

13. The scan mechanism of claim 12, wherein the clock source module includes a crystal oscillator.

14. The scan mechanism of claim 1, wherein the motor includes a brushless motor.

15. The scan mechanism of claim 1, wherein:
in response to the plurality of controllers being included, a part of the plurality of motors are controlled by independent controllers, and each group of motors of another part of the plurality of motors are controlled by a shared controller; or
each group of motors are controlled by the shared controller, each group of motors including at least two motors.

16. The scan mechanism of claim 1, wherein:
the scan mechanism further includes electronic speed controls (ESC);
a quantity of ESCs is equal to a quantity of the plurality of controllers;
the controller is arranged at a corresponding ESC; and
the ESC is fixed at an outer shell of the motor controlled by the corresponding controller.

17. The scan mechanism of claim 16, wherein:
the ESC includes a control interface;
the rotor includes a control end, the control interface of the ESC being arranged adjacent to the control end of the rotor of the corresponding motor, and the control interface being connected to the corresponding control end via a conductive wire.

18. The scan mechanism of claim 1, wherein the optical element includes at least one of a lens, a reflection mirror, a prism, a galvanometer, a grating, a liquid crystal, or an optical phased array.

19. A ranging apparatus comprising:
a housing;
a ranging device configured to emit a light pulse sequence and receive a light pulse sequence reflected by a detected object;
a scan mechanism configured to change a transmission direction of at least a light pulse sequence emitted by an emission device and then emit the light pulse sequence and including:
a plurality of optical elements;
a plurality of motors corresponding to the plurality of optical elements, a motor including a hollow rotor, and an optical element being arranged at the rotor of a corresponding motor; and
a controller controlling the plurality of motors; or
a plurality of controllers, at least one of the plurality of controllers controlling at least two of the plurality of motors;
wherein:
in response to one controller controlling at least two motors, the controller controls the at least two motors to rotate at a predetermined angle difference based on a first synchronization strategy; and
in response to one controller controlling one motor, the controller controls the motor and another at least one motor to rotate at the predetermined angle difference based on a second synchronization strategy; and
a main control circuit fixed at the housing and configured to control the controller to operate.

20. A mobile platform comprising:
a platform body; and
a ranging apparatus arranged at the platform body and including:
a housing;
a ranging device configured to emit a light pulse sequence and receive a light pulse sequence reflected by a detected object;
a scan mechanism configured to change a transmission direction of at least a light pulse sequence emitted by an emission device and then emit the light pulse sequence and including:
a plurality of optical elements;
a plurality of motors corresponding to the plurality of optical elements, a motor including a hollow rotor, and an optical element being arranged at the rotor of a corresponding motor; and
a controller controlling the plurality of motors; or
a plurality of controllers, at least one of the plurality of controllers controlling at least two of the plurality of motors;
wherein:
in response to one controller controlling at least two motors, the controller controls the at least two motors to rotate at a predetermined angle difference based on a first synchronization strategy; and
in response to one controller controlling one motor, the controller controls the motor and another at least one motor to rotate at the predetermined angle difference based on a second synchronization strategy; and
a main control circuit fixed at the housing and configured to control the controller to operate.
